(19) United States
(12) Patent Application Publication
(10) Pub. No.: US 2015/0355408 A1
(43) Pub. Date: Dec. 10, 2015

(54) ILLUMINATION LAMP HAVING LIGHT GUIDE BAR

(71) Applicant: SIRIUSTEK INCORPORATED, TAINAN CITY (TW)

(72) Inventors: JYH-HUEI LAY, TAINAN CITY (TW); CHIEN-LUNG LEE, TAINAN CITY (TW); HUNG-WEI YANG, TAINAN CITY (TW); HSIN-LIANG LAI, TAINAN CITY (TW)

(21) Appl. No.: 14/300,381

(22) Filed: Jun. 10, 2014

(51) Int. Cl. F21V 8/00; F21V 29/74

(52) U.S. Cl. CPC G02B 6/0096; F21V 29/74

(57) ABSTRACT

An illumination lamp having light guide bar is to dispose with at least a luminous component at an end of the light guide bar, and a plurality of mesh points is formed on a surface of the light guide bar. The luminous component comprises a heat dissipation base, a fastening base, a circuit board and two pins. The fastening base is assembled to the heat dissipation base and disposed with a through hole. An insertion slot is extended from an end of the fastening base. The circuit board is disposed with at least a LED component and placed between the heat dissipation base and the fastening base. The pins are disposed in the insertion slot of the fastening base and engaged to the circuit board. Accordingly, after conducting the luminous component, light source of the LED component enters in the light guide bar. [Light beam can be diffused by utilizing the refraction of the mesh points disposed on the surface of the light guide bar. In addition, the length of the light guide bar and quantity of the luminous component can be regulated to regulate brightness and light beam distribution.

### BACKGROUND OF THE INVENTION

1. Field of the Invention

The invention relates to an illumination lamp, and more particularly to assemble LED components at a light guide bar so that light beam can be uniformly distributed through diffusion of the light guide bar to improve the problem for LEDs glaring vision.

2. Description of the Related Art

Under the development of advanced technology and the requirement of environmental protection, a conventional lamp or lamp tube has been gradually replaced with LED lamps (light emitting diodes) having power saving and environmental friendly, and the LED lamps are rapidly applied in each field. For a lamp housing applied to exhibit or advertisement, not only the conventional lamp tube may generate high temperature, hot and consume power but also the lamp tube is a standard length and may be restricted in usage. Therefore, the conventional lamp tube is gradually replaced with LEDs to allow the lamp housing to comply with the trend of lightweight and thinner thickness.

According U.S. patent application Ser. No. 13/936,115, a title of “Thin-wall panel modular light box sign and display” is to dispose a plurality of ribs between two external walls so that a series of chambers is partitioned inside a thinner wall plate, and at least a light strip is positioned at an edge or one or the plurality of chambers. Further, it can be applied to advertisement signboards, doorplates and signs, exit signs or illumination purposes.

According U.S. patent application Ser. No. 13/879,281, a title of “Profile Rail, Connecting Element, Illuminating Module, Lighting System and Light Box” is to dispose at least a bottom wall at a DIN guide rail, and two side walls are disposed at two corresponding sides of the bottom wall to allow the DIN guide rail to have a containing space for exactly containing or fastening at least a light emitting module by means of pressing and embedding so as to simplify the mounting flow path, and the brightness and light distribution can be regulated by increasing or moving the light emitting module disposed on the DIN guide rail in accordance with using condition.

However, the single LED may form a point-like light source while in direct irradiation. Not only the point-like light source leads to glare and light pollution but also the point-like light source may easily result in non-uniform brightness due to smaller light emitting angle. Consequently, the phenomenon of non-uniform brightness may easily occur while in use. If light beam is required to be uniformly irradiated and the angle of light emitting is improved, a plurality of LEDs must be applied at the same time, and high shielding and diffusible material or thickened optical chamber is adopted for the LED. However, the plurality of LEDs may lead to high costs, easily allow the lamp housing to generate heat and is unfavorable to the conversion efficiency of inputted energy resource. While achieving power saving at the same time, overcoming problems of light pollution and non-uniform brightness caused by LEDs and satisfying thinner development are urgently necessary to improve for the conventional lamp housing.

### SUMMARY OF THE INVENTION

Therefore, since a conventional lamp tube consumes power and is restricted by the length, and moreover LEDs may be limited in quantity as well, it is a primary objective of the present invention to utilize luminous components and a light guide bar to replace utilization modes of conventional lamp tubes and LED lamps, thereby achieving efficacies of saving energy, eliminating glare and light pollution and uniform irradiation.

Another objective of the invention is to change the length of the light guide bar in accordance with utilization requirement by increasing quantity of luminous components, and the application scope can be enhanced rather than restrict the length of formal lamp tubes.

A further objective of the invention is to easily detach, replace and implement the light guide bar through simple fastening structures.

To achieve the foregoing objectives, the invention provides an illumination lamp having light guide bar disposed with at least a luminous component at an end of a light guide bar, and a plurality of mesh points is formed on a surface of the light guide bar. The luminous component comprises a heat dissipation base, a fastening base, a circuit board and two pins. The fastening base is assembled and combined to the heat dissipation base and having a through hole. An insertion slot is extended from an end of the fastening base. The circuit board is disposed with at least a LED component and placed between the heat dissipation base and the fastening base. The pins are disposed in the insertion slot of the fastening base and engaged to the circuit board.

In an embodiment of the invention, a concave groove is disposed at an end surface of the fastening base and for placing the circuit board.

In an embodiment of the invention, the mesh points are formed on the light guide bar through printing.

In an embodiment of the invention, the LED component can be white, RGB single color, stage discoloration or flicker light-emitting.

In an embodiment of the invention, the heat dissipation base is disposed with a plurality of heat dissipation fins.

In an embodiment of the invention, the lamp further comprises a bottom base, and the bottom base is disposed to the fastening base.

In an embodiment of the invention, the fastening base is disposed with an engagement member, and an engagement slot corresponding to the engagement member is disposed to the heat dissipation base so that the heat dissipation base is embedded with the engagement member of the fastening base through the engagement slot.

In an embodiment of the invention, two ends of the light guide bar are respectively disposed with a luminous component, and the pins between the luminous components are disposed with wires correspondingly connected.

Accordingly, after conducting the luminous component, light source of the LED component enters in the light guide bar. Light beam can be expanded by utilizing the refraction of the mesh points disposed on the surface of the light guide bar. In addition, the length of the light guide bar and quantity of the luminous component can be regulated in accordance with utilization requirement so as to regulate brightness and light-emitting area. It can match the demand of thinner products and enhance the application scope.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a three-dimensional decomposition drawing of a first embodiment according to the invention;

FIG. 2 is a three-dimensional decomposition drawing of a luminous component of a first embodiment according to the invention;

FIG. 3 is a partial cross-sectional drawing of a first embodiment according to the invention;

FIG. 4 is a three-dimensional drawing of a first embodiment according to the invention;

FIG. 5 is a schematic diagram of a first embodiment according to the invention;

FIG. 5-A is a partial enlarged drawing of an utilization of a first embodiment according to the invention;

FIG. 6 is a schematic diagram of a first embodiment applied in a lamp housing according to the invention;

FIG. 7 is a cross-sectional drawing of a first embodiment applied in a lamp housing according to the invention;

FIG. 8 is a schematic diagram of a first embodiment applied to a roof advertising lamp according to the invention;

FIG. 9 is an assembled schematic diagram of a second embodiment according to the invention;

FIG. 10 is a three-dimensional drawing of a second embodiment according to the invention.

### DETAILED DESCRIPTION OF THE PREFERRED EMBODIMENTS

The technical content of the present invention will become apparent by the detailed description of the following embodiments and the illustration of related drawings as follows.

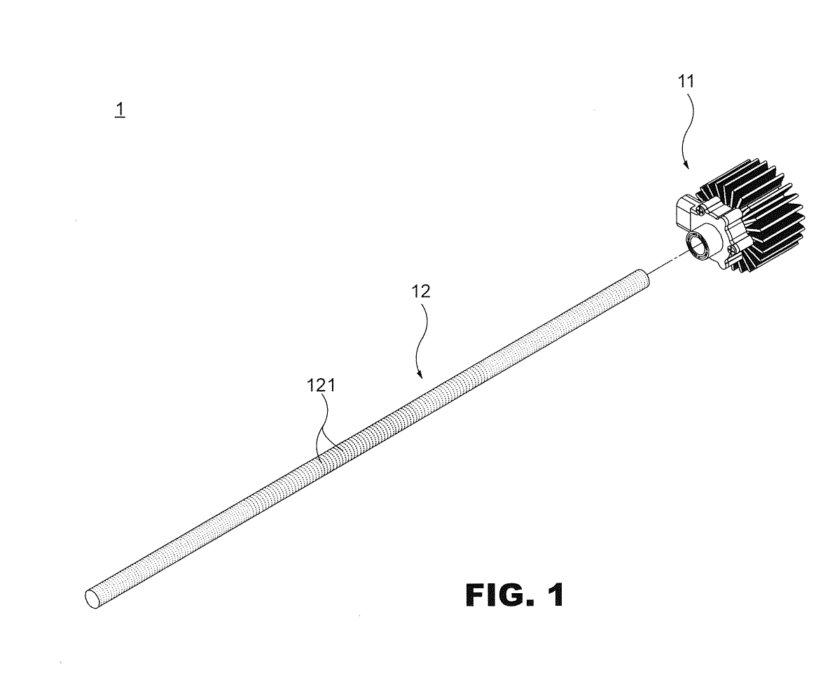

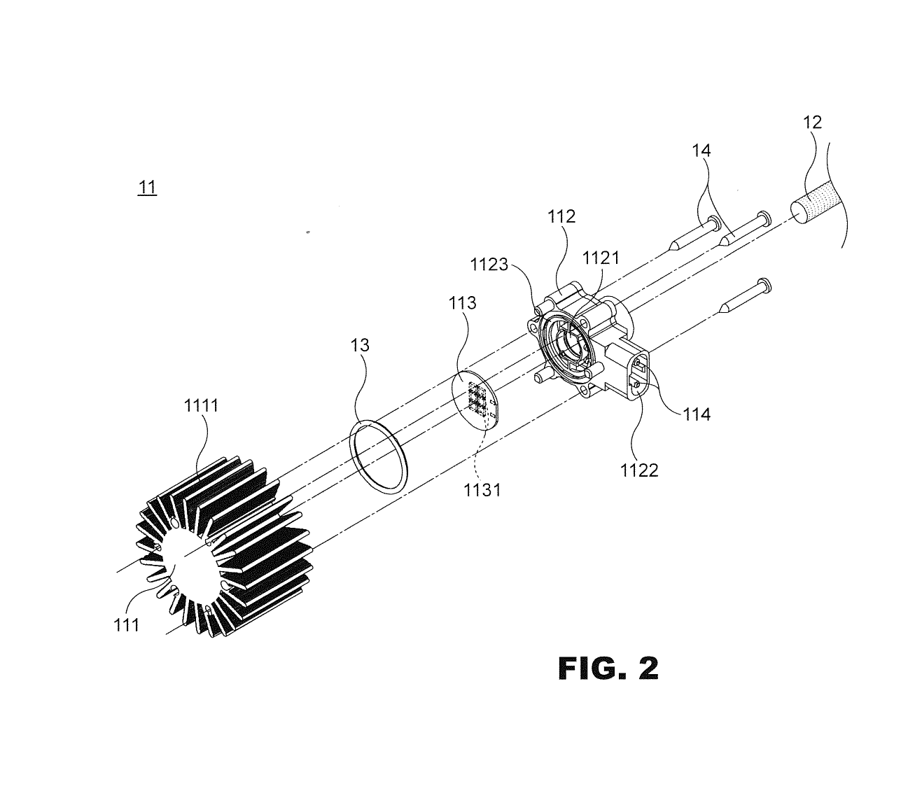

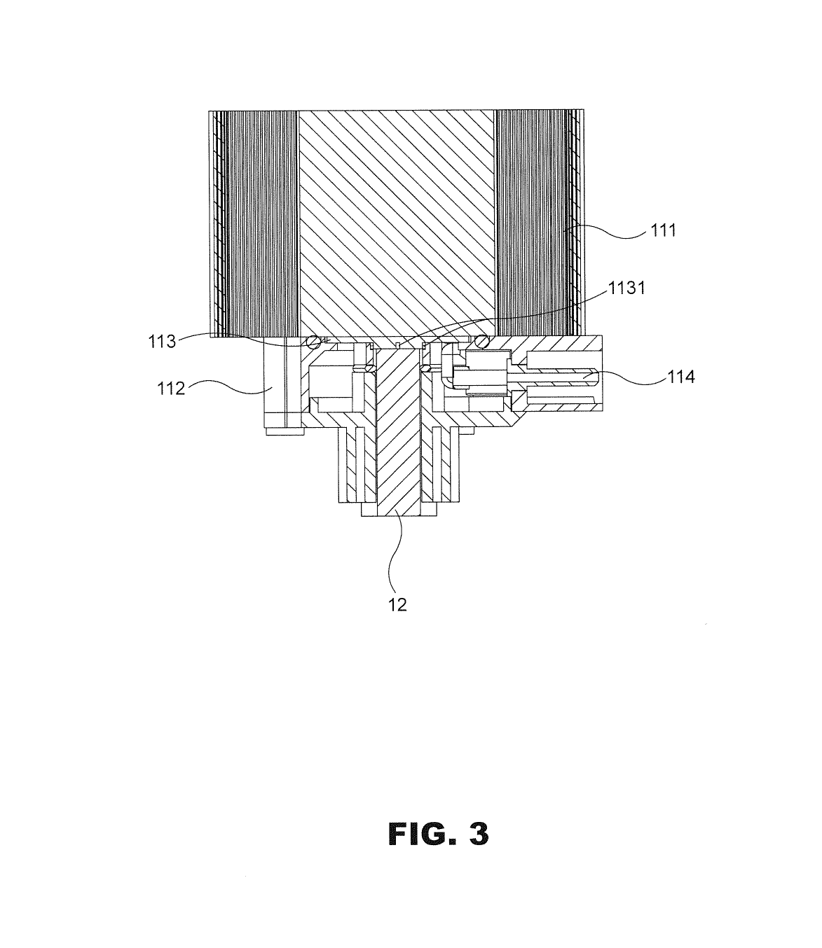

With reference to FIG. 1 and FIG. 2, the lamp 1 comprises at least a luminous component 11 and a light guide bar 12. The luminous component 11 is assembled to an end of the light guide bar 12 and formed with a plurality of mesh points 121 having specific sizes and distances. Preferably, the mesh point 121 is formed by printing. The luminous component 11 comprises a heat dissipation base 111, a fastening base 112, a circuit board 113 and two pins 114. The heat dissipation base 111 is disposed with a plurality of heat dissipation fins 1111 and assembled to the fastening base 112. The fastening base 112 has a through hole 1121 and extended with an insertion slot 1122 at the end. The circuit board 113 is disposed with at least a LED component 1131. Preferably, the LED component 1131 can be white, RGB single color or control stage discoloration or flicker light-emitting by using the circuit board 113 and placed between the heat dissipation base 111 and the fastening base 112. The two pins 114 are disposed in the insertion slot 1122 of the fastening base 112 and engaged with the circuit board 113 (as shown in FIG. 3).

With reference to FIG. 1 to FIG. 3, while assembling the luminous component 11. the two pins 114 are fastened in the insertion slot 1122 of the fastening base 112. In the embodiment, the insertion slot 1122 is located at a side of the fastening base 112. The circuit board 113 is placed to the fastening base 112. and the LED component 1131 of the circuit board 113 is toward a direction of the light guide bar 12. Preferably, an end surface of the fastening base 112 is disposed with a concave groove 1123 for placing the circuit board 113 to prevent the circuit board 113 from being shifted. Next, the heat dissipation base 111 is combined with the fastening base 112. Preferably, the combination is fastened by locking members 14, and a gasket 13 is further disposed between the heat dissipation base 111 and the fastening base 112 to improve its tightness.

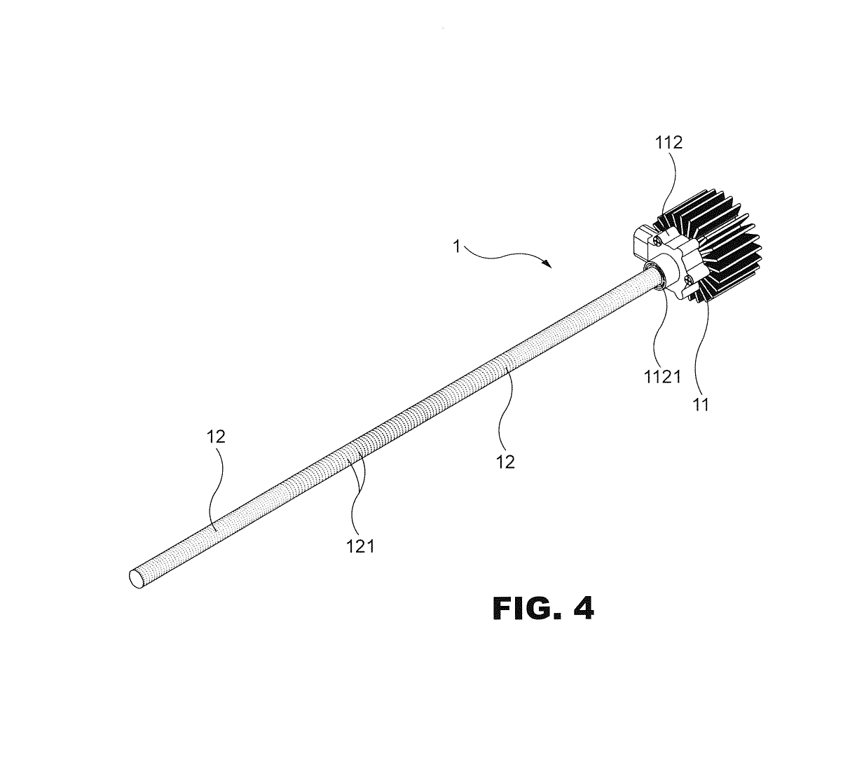

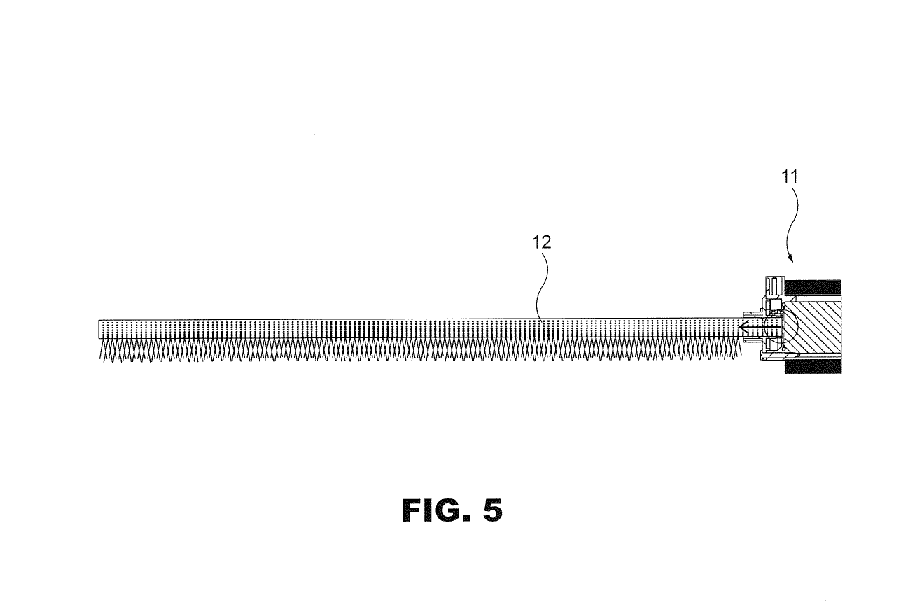

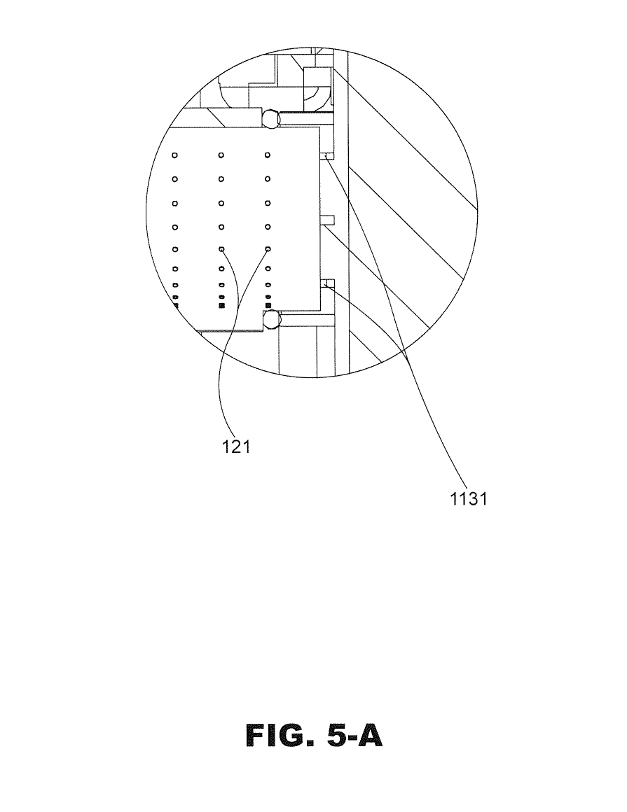

Next, with reference to FIG. 4 for a three-dimensional drawing of a first embodiment according to the invention is depicted. With the through hole 1121 of the fastening base 112, the luminous component 11, which is completely assembled, can assemble the end of the light guide bar 112 at the luminous component 11 so that after conducting the power source of the luminous component 11, the light source emitted by the LED component 1131 therein can pass through the light guide bar 12 (with reference to FIG. 5 and FIG. 5-A), and light beam of the LED component 1131 is refracted by the mesh points 121 arranged on the surface of the light guide bar 12 to allow the light guide bar 12 to emit uniform light and to avoid problems of non-uniform brightness and light pollution.

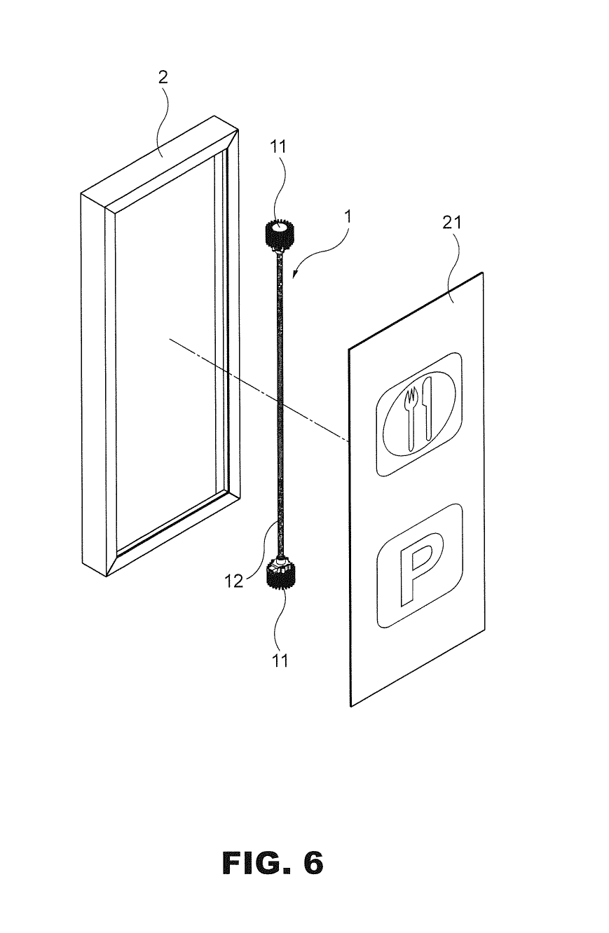

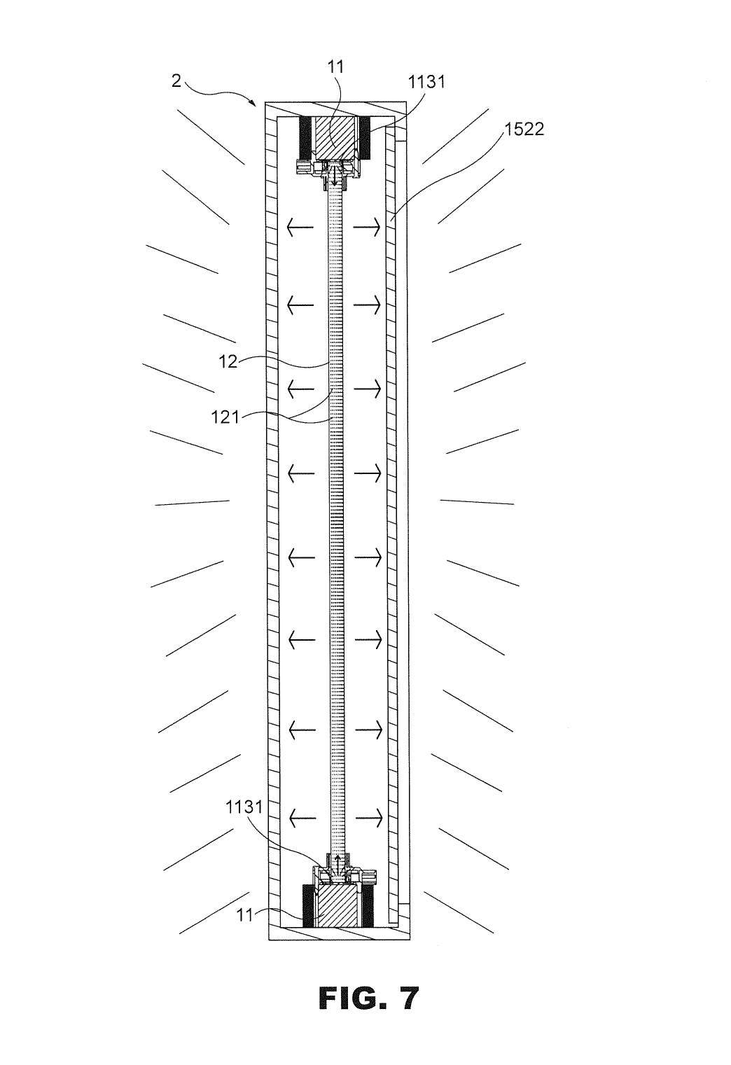

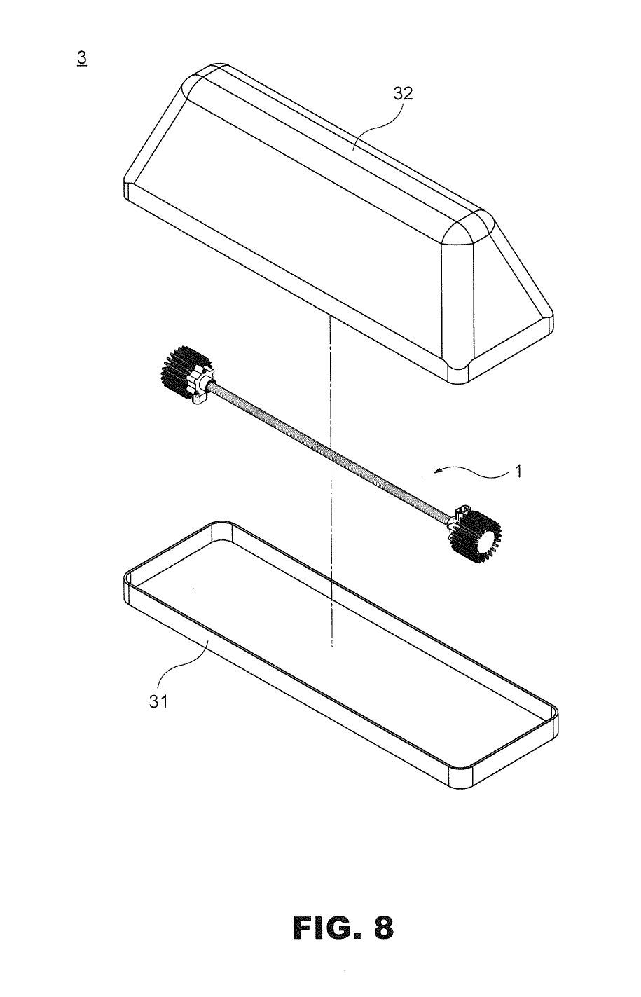

In addition, the length of the light guide bar 12 can be regulated according to desire sizes. With reference to FIG. 6 for a schematic diagram of the first embodiment according to the invention applied to a lamp housing. When the lamp 1 is applied to a lamp housing 2 having larger size or specification, the length of the light guide bar 12 can be regulated to match application demand, and a luminous component 11 is respectively combined at two ends of the light guide bar 12 so that light beam is irradiated into the light guide bar 12 (with reference to FIG. 7) from the LED components 1131 at two sides, and light is refracted by the mesh points 121 printed on the surface of the light guide bar 12. The two side light emitting or full perimeter light emitting of the light guide bar 12 is controlled by regulating the distribution state of the mesh points so that the lamp housing 2 may not be restricted by the length of the conventional lamp tube. Moreover, the brightness may not reduce due to the extension of the light guide bar 12 to allow the lamp housing 2 emitting light and to clearly show the advertising convent of a translucent panel 21. Further, the thickness of the lamp housing 2 can be reduced to satisfy thinner development. The lamp 1 can be applied to a roof advertising lamp 3 (with reference to FIG. 8). The lamp 1 is placed between the base body 31 and the lamp housing 32, and the lamp 1 is fastened to the lamp housing 32. It should be noted that while replacing the light guide bar 12, only the light guide bar 12 is taken out of the through hole 1121 of the fastening base 112 (with reference to FIG. 4) to perform replacement motion. Not only the installation can be easily performed but also the detachment can be carried out to have time saving and convenience.

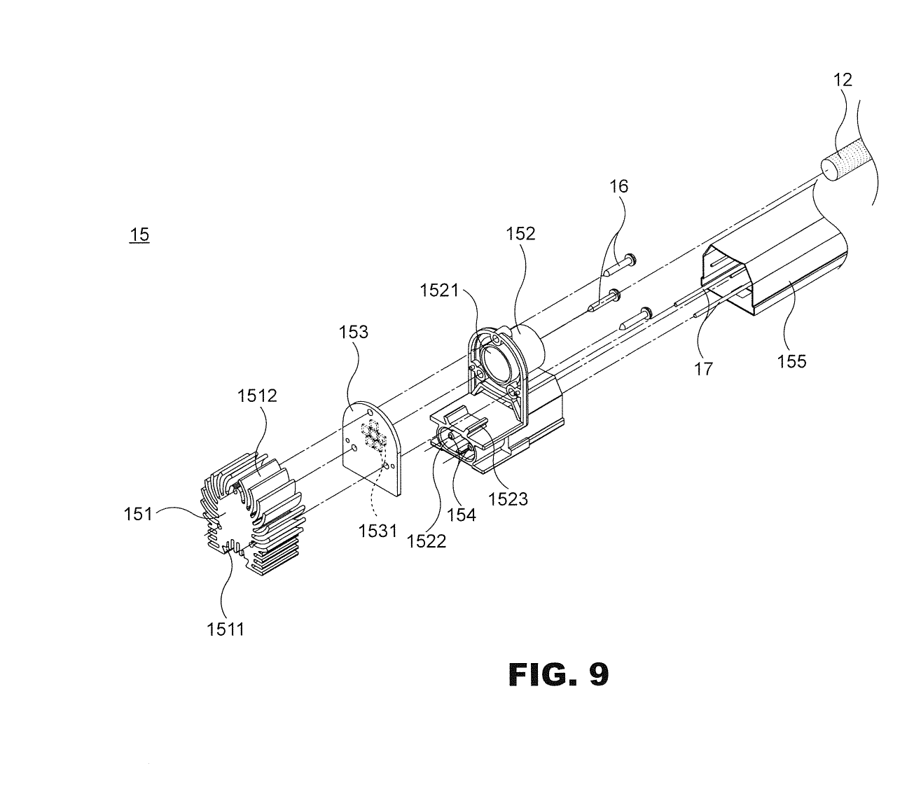

Next, with reference to FIG. 9 for an assembling schematic diagram of a second embodiment according to the invention is depicted. In the embodiment, its luminous component 15 comprises a heat dissipation base 151, a fastening base 152, a circuit board 153, two pins 154 and a bottom base 155. The heat dissipation base 51 is disposed with a plurality of heat dissipation fins 1512 and assembled to the fastening base 152. The fastening base 152 has a through hole 1521, and an insertion slot 1522 is extended from its end. In the embodiment, the insertion slot 1522 is disposed at the bottom portion of the fastening base 152, and an engagement member 1523 is disposed to the fastening base 152, and an engagement slot 1511 corresponding to the engagement member 1523 is disposed to the heat dissipation base 151 so that the heat dissipation base 151 can be embedded with the engagement member 1523 of the fastening base 152 through the engagement slot 1511, and it can be fastened by the locking member 15. The circuit board 153 is disposed with at least a LED component 1531 and placed between the heat dissipation base 151 and the fastening base 152. Preferably, the LED component 1531 can be white, RGB single color or control stage discoloration or flicker light-emitting by using the circuit board 153. The two pins 154 are disposed in the insertion slot 1522 of the fastening base 152 and connected to the circuit board 153. The bottom base 155 can be assembled to the fastening base 152.

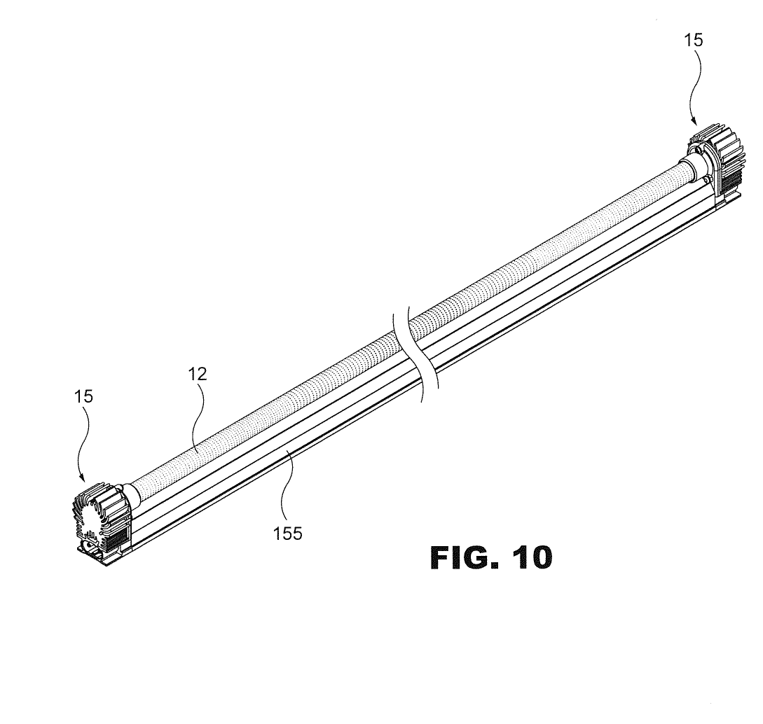

While in use, the light guide bar 12 is assembled in the through hole 1521 of the fastening base 152. In addition, two ends of the light guide bar 12 can be respectively disposed with a luminous component 15 (with reference to FIG. 10), and a wire 17 is disposed inside the bottom base 115 to allow two ends of the wire 17 to respectively connect the two pins 154 of the luminous components 15 so that the luminous component 15 at one end supplies power while the luminous component 15 at another end also emits light.

The invention assembles the LED component at the light guide bar to allow light source to form uniform distribution through the diffusion of the light guide bar, and glare and light pollution can also be effectively overcome. Moreover, with simple assembling structures, the light guide bar can be easily detached and assembled, and the length can be further regulated in accordance with demands so that it is much better than conventional lamp tubes.

While the means of specific embodiments according to the present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. An illumination lamp having light guide bar disposed with at least a luminous component at an end of a light guide bar, a plurality of mesh points disposed on a surface of the light guide bar, the luminous component comprising:
a heat dissipation base;
a fastening base assembled and combined to the heat dissipation base, the fastening base having a through hole, an insertion slot extended from an end of the fastening base;
a circuit board having at least a LED component and placed between the heat dissipation base and the fastening base; and
two pins disposed in the insertion slot of the fastening base and engaged with the circuit board.

2. The illumination lamp having light guide bar of claim 1, wherein an end surface of the fastening base is disposed with a concave groove placed by the circuit board.

3. The illumination lamp having light guide bar of claim 1, wherein the mesh point is formed on the light guide bar through printing.

4. The illumination lamp having light guide bar of claim 1, wherein the heat dissipation base is disposed with a plurality of heat dissipation fins.

5. The illumination lamp having light guide bar of claim 1, wherein the lamp further has a bottom base, and the bottom base is assembled to the fastening base.

6. The illumination lamp having light guide bar of claim 1, wherein the fastening base is disposed with an engagement member, and an engagement slot corresponding to the engagement member is disposed to the heat dissipation base so that the heat dissipation base is embedded with the engagement member of the fastening base through the engagement slot.

7. An illumination lamp having light guide bar disposed with at least a luminous component at an end of a light guide bar, a plurality of mesh points disposed on a surface of the light guide bar, the luminous component comprising:
a heat dissipation base;
a fastening base assembled and combined to the heat dissipation base, the fastening base having a through hole, an insertion slot extended from an end of the fastening base;
a circuit board disposed with at least a LED component and placed between the heat dissipation base and the fastening base;
two pins disposed in the insertion slot of the fastening base and engaged to the circuit board; and
a bottom base assembled and combined to the fastening base.

8. The illumination lamp having light guide bar of claim 7, wherein the mesh point is formed on the light guide bar through printing.

9. The illumination lamp having light guide bar of claim 7, wherein the heat dissipation base is disposed with a plurality of heat dissipation fins.

10. The illumination lamp having light guide bar of claim 7, wherein the fastening base is disposed with an engagement member. and an engagement slot corresponding to the engagement member is disposed to the heat dissipation base so that the heat dissipation base is embedded with the engagement member of the fastening base through the engagement slot.

11. An illumination lamp having light guide bar respectively disposed with a luminous component at two ends of a light guide bar, a plurality of mesh points disposed on a surface of the light guide bar, the luminous component comprising:
a heat dissipation base;
a fastening base assembled and combined to the heat dissipation base, the fastening base having a through hole, an insertion slot extended from an end of the fastening base;
a circuit board disposed with at least a LED component and placed between the heat dissipation base and the fastening base; and
two pins disposed in the insertion slot of the fastening base and engaged to the circuit board.

12. The illumination lamp having light guide bar of claim 11, wherein an end surface of the fastening base is disposed with a concave groove placed by the circuit board.

13. The illumination lamp having light guide bar of claim 11, the mesh point is formed on the light guide bar through printing.

14. The illumination lamp having light guide bar of claim 11, wherein the heat dissipation base is disposed with a plurality of heat dissipation fins.

15. The illumination lamp having light guide bar of claim 11. wherein the lamp further has a bottom base, and the bottom base is assembled to the fastening base.

16. The illumination lamp having light guide bar of claim 11, wherein the fastening base is disposed with an engagement member, and an engagement slot corresponding to the engagement member is disposed to the heat dissipation base so that the heat dissipation base is embedded with the engagement member of the fastening base through the engagement slot.

17. The illumination lamp having light guide bar of claim 11, wherein the pins between the luminous components are disposed with wires correspondingly connected.
